(19) United States
(12) Patent Application Publication
(10) Pub. No.: US 2021/0190146 A1
(43) Pub. Date: Jun. 24, 2021

(54) DOUBLE LIPPED SEALED BEARING

(71) Applicant: HMS Industries, Westlake, OH (US)

(72) Inventor: Biri Saluja, Westlake, OH (US)

(73) Assignee: HMS Industries, Westlake, OH (US)

(21) Appl. No.: 16/722,744

(22) Filed: Dec. 20, 2019

(51) Int. Cl. F16C 33/78; F16C 19/06

(52) U.S. Cl. CPC F16C 33/7823; F16C 19/06

(57) ABSTRACT

Provided in this disclosure is a seal for a hearing having a seal body that, includes a metal shield portion for engaging an outer ring of the bearing and thus the outer diameter of the seal body. The seal body also includes a rubber portion molded onto an internal face of the metal shield portion and extending beyond the metal shield portion for engaging an inner ring of the bearing, thereby defining the inner diameter of the seal body. The present seal provides a bearing with superior protection against external debris damage, improper handling, and/or aggressive installation while obtaining improved sealing around the inner and outer rings of the bearing.

### I. BACKGROUND

### A. Technical Field

This invention pertains to the field of bearings. More particularly, the invention pertains to the field of sealed bearings that retain a lubricant while preventing the entry of contaminants.

### B. Description of Related Art

Rolling-element bearings are known in the art for supporting a load during rotation. Such bearings include rolling elements, including spherical balls or cylindrical rollers, that are placed between an outer ring and an inner ring. Typically, one bearing ring or the other is held stationary while the other bearing ring is permitted to rotate. The rolling elements roll between the two bearing rings with little frictional resistance. The rolling elements are typically lubricated with a lubricant such as grease or the like to further lower friction and reduce wear on the rolling elements and bearing rings.

One problem with prior art bearings is containment since lubricant tends to escape from the interior of the bearing due to the motion of the moving components. Another problem is contamination since common debris tends to enter the bearing from typical environments, such as the outdoors, roadways, and machinery. Sealed bearings are known in the art and include a seal intended to increase containment and reduce contamination. However, typical sealed bearing designs fail to provide adequate mitigation of these ongoing problems. There remains a need for a sealed bearing that overcomes these known problems.

### II. SUMMARY

Provided in this disclosure is a seal for a bearing. The seal includes a seal body that is interposed between an outer ring and an inner ring of a bearing. The seal body is retained between an outer ring groove formed on the outer ring and an inner ring groove formed on the inner ring. Preferably, there are two seals, to cover and protect each of the two sides of a cylindrically shaped bearing.

The seal body includes a metal shield portion for engaging either the outer ring groove or the inner ring groove for providing rigid mounting of the seal. Preferably, the metal shield portion engages the outer ring groove and thereby defines the outer diameter of the seal body. However, in an alternative embodiment, the metal shield portion can also engage the inner ring groove and thereby define the inner diameter of the seal body.

The seal body also includes a rubber portion for engaging either the outer ring groove or the inner ring groove for providing tight sealing. The rubber portion is molded onto an internal face of the metal shield portion and extends beyond the metal shield portion into the respective groove. Preferably, the rubber portion engages the inner ring groove and thereby defines the inner diameter of the seal body. However, in an alternative embodiment, the rubber portion can also engage the outer ring groove and thereby define the outer diameter of the seal body.

According to an aspect of the invention, the present seal has combined characteristic features of a pressed metal shield along with a synthetic rubber labyrinth seal.

According to another aspect of the invention, the present seal provides a bearing with superior protection against external debris damage, improper handling, and/or aggressive installation while obtaining improved sealing around the inner and outer rings of the bearing.

According to yet another aspect of the invention, the present seal allows for rigid mounting and superior protection against external debris damage.

According to still another aspect of the invention, the present seal provides excellent protection against water intrusion while also containing lubricant, which in turn increases bearing efficiency and produce life.

Other benefits and advantages of this invention will become apparent to those skilled in the art to which it pertains upon reading and understanding of the following detailed specification.

### III. BRIEF DESCRIPTION OF THE DRAWINGS

The disclosed sealed bearing may take physical form in certain parts and arrangement of parts, embodiments of which will be described in detail in this specification and illustrated in the accompanying drawings which form a part hereof and wherein:

FIG. 1 is a perspective view of a half-section of the bearing in accordance with an exemplary embodiment of the present invention.

FIG. 2 is a side-sectional view of the bearing of FIG. 1, shown along a line A-A, in accordance with an exemplary embodiment of the present invention.

FIG. 3 is a detail view of a portion of the side-sectional view of FIG. 2, in accordance with an exemplary embodiment of the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

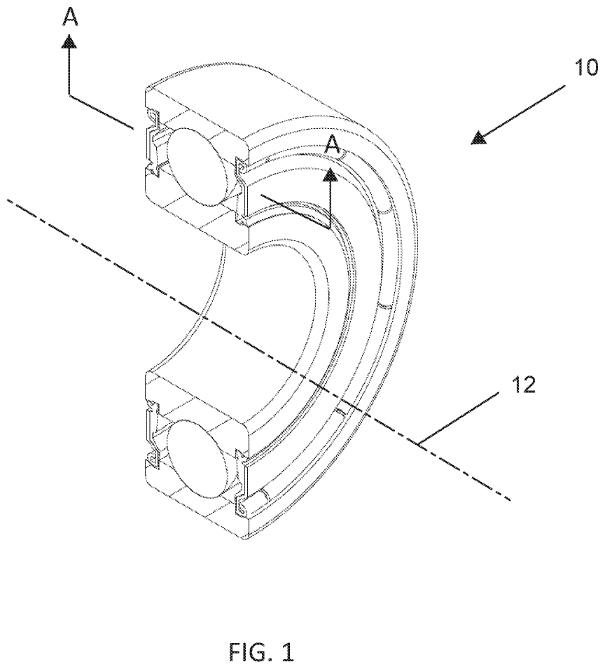

A sealed bearing 10 in accordance with the present invention is generally shown in the view of FIG. 1. It is to be understood and appreciated that the entire sealed bearing has a body generally in the shape of a continuous cylindrical annulus, centered along a cylindrical axis 12 which represents an axis of rotation for the sealed bearing 10. The view of FIG. 1 represents a half-section generally symmetrical of the complete sealed bearing 10.

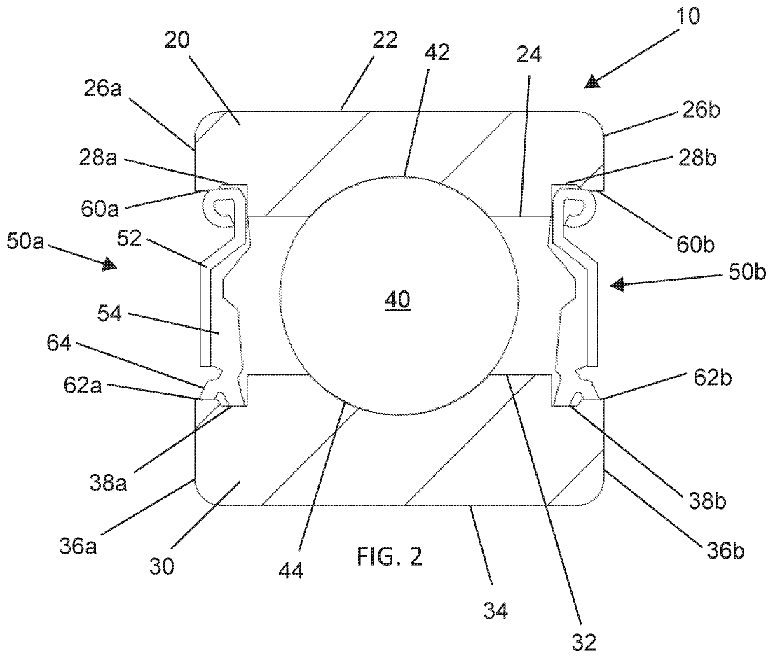

FIG. 2 is a cross-section of the annular sealed bearing 10 taken along the sectional line A-A shown in FIG. 1. The sealed bearing 10 includes an outer ring 20 and an inner ring 30. The outer ring 20 is a generally cylindrical outer ring 20 centered along the cylindrical axis 12. The outer ring 20 includes an outer ring exterior cylindrical surface 22, which faces outward from the cylindrical axis 12 of the sealed bearing 10. The outer ring 20 also includes an outer ring interior cylindrical surface 24, which faces inwardly toward the cylindrical axis 12. The outer ring 20 also includes first and second outer ring edge surfaces 26a, 26b spanning the respective exterior and interior cylindrical surfaces 22, 24.

The interior cylindrical surface 24 of the outer ring 20 includes first and second outer ring grooves 28a, 28b. Each of the outer ring grooves 28a, 28b are inset from the respective first and second outer ring edge surfaces 26a, 26b. That is to say, the first outer ring groove 28a is formed in the outer ring interior cylindrical surface 24 at a position that is set in from first edge surface 26a. Similarly, the second outer ring groove 28b is formed in the interior outer ring cylindrical surface 24 at a position that is set in from second edge surface 26b. These outer ring grooves 28a, 28b help retain the present seal body, as will be explained in detail hereinbelow.

The inner ring 30 of the sealed bearing 10 is a generally cylindrical inner ring 30 also centered along the cylindrical axis 12. The inner ring 30 is generally coaxial with the outer ring 20. The inner ring 30 has an outer diameter smaller than the inner diameter of the outer ring 20 so that the inner ring 30 can be retained concentrically within the outer ring 20 with a space in between that defines a volume for retaining rolling elements, as will be explained in detail hereinbelow. The inner ring 30 includes an inner ring exterior cylindrical surface 32, which faces outward from the cylindrical axis 12 of the sealed bearing 10. The inner ring 30 also includes an inner ring interior cylindrical surface 34, which faces inwardly toward the cylindrical axis 12 and generally defines a bore that can receive a stationary axle, rotating shaft, or other such load-bearing structure used with bearings, as is understood in the art. The inner ring 30 also includes first and second inner ring edge surfaces 36a, 36b which span the respective exterior and interior cylindrical surfaces 32, 34.

The exterior cylindrical surface 32 of the inner ring 30 includes first and second inner ring grooves 38a, 38b. Each of the inner ring grooves 38a, 38b are inset from the respective first and second outer ring edge surfaces 36a, 36b. That is to say, the first inner ring groove 38a is formed in the exterior cylindrical surface 32 at a position that is set in from first edge surface 36a. Similarly, the second inner ring groove 38b is formed in the exterior cylindrical surface 32 at a position that is set in from the second edge surface 36b. These inner ring grooves 38a, 38b cooperate with the outer ring grooves 28a, 28b of the outer ring 20 to retain the present seal body, as will also be explained in detail hereinbelow.

The sealed bearing 10 of the present invention also includes a plurality of rolling elements 40 retained between the interior cylindrical surface 24 of the outer ring 20 and the exterior cylindrical surface 32 of the inner ring 30. These rolling elements 40 provide rolling contact with both the outer ring 20 and the inner ring 30. Though only a single rolling element 40 is depicted in FIG. 2, it is to be appreciated that the plurality of rolling elements 40 are distributed along the entire annular body of the sealed bearing 10, occupying the volume enclosed by the outer ring 20 and the inner ring 30, as is understood and appreciated in the art. The plurality of rolling elements 40 can be retained in place against contact with each other using a separator (not shown) or any other such conventional configuration as is known in the art.

As particularly shown in FIG. 2, an exemplary embodiment of the sealed bearing 10 includes a plurality of rolling elements 40 in the form of bearing balls 40, having a generally spherical shape. The interior cylindrical surface 24 of the outer ring 20 includes an outer ring ball raceway 42. Similarly, the exterior cylindrical surface 32 of the inner ring 30 comprises an inner ring ball raceway 44. These respective raceways 42, 44 define contact surfaces to provide and enable the rolling contact between the bearing balls 40 and the outer and inner rings 20, 30. As particularly shown in FIG. 2, the respective ball raceways 42, 44 are formed as concave surfaces having generally the same shape, size and diameter as the respective bearing balls 40. It is to be understood and appreciated that the ball raceways 42, 44 are generally annular channels or furrows having the corresponding shape, size and diameter as the bearing balls 40. In this way, the ball raceways 42, 44 have a mating relationship to the convex diameter of the plurality of bearing balls.

While bearing balls 40 are shown as an exemplary embodiment of the present invention, it is to be understood and appreciated that other types of rolling elements can also be adapted, such as cylindrical roller bearings or needle bearings or the like, all without departing from the present invention.

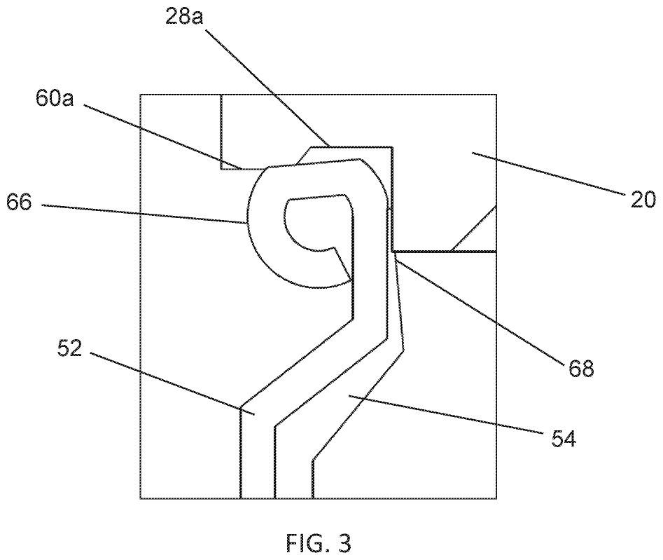

As shown in the side-sectional view of FIG. 2 and particularly in the close-up, detail view of FIG. 3, the present sealed bearing 10 includes first and second seals each composed of a respective first and second seal body 50a, 50b. Each seal body 50a, 50b is provided for interposition between the outer ring 20 and the inner ring 30 of the sealed bearing 10. As mentioned hereinabove, each seal body 50a, 50b is retained between a respective one of the outer ring grooves 28a, 28b formed on the outer ring 20 and a respective inner ring groove 38a, 38b formed on the inner ring 30. That is to say, a first seal composed of a first seal body 50a is retained between the first outer ring groove 28a and the first inner ring groove 38a. Similarly, a second seal composed of a second seal body 50b is retained between the second outer ring groove 28b and the second inner ring groove 38b.

Each seal body 50a, 50b includes a metal shield portion 52 and a rubber portion 54. While FIGS. 2 and 3 especially show the details of the components of the first seal including the first seal body 50a, it is to be appreciated that the second seal body 50b is symmetrically identical and includes corresponding components. The metal shield portion 52 of the first seal body 50a can be provided for engaging one of the outer or inner ring grooves 28a, 38a, while the rubber portion 54 can be provided for engaging the respective other of the outer or inner ring grooves 28a, 38a, in order to provide rigid mounting of the first seal body 50a of the first seal.

As depicted in the exemplary embodiments of the figures, the first and second seals defined by the respective seal bodies 50a, 50b are generally annular and each thus have an outer diameter and an inner diameter. In a preferred embodiment, the metal shield portion 52 of the first seal defines the outer diameter of the first seal body 50a and thus engages the first outer ring groove 28a. Correspondingly, the rubber portion 54 of the first seal defines the inner diameter of the first seal body 50a and thus engages the first inner ring groove 38a.

It is to again be understood and appreciated that, similarly, the second seal body 50b of the second seal is respectively configured so that similar components define the outer and inner diameter of the seal body 50b and thus respectively engage the second outer and inner ring grooves 28b, 38b. Similar corresponding symmetrically identical components and structures are to be understood for all the descriptions hereinabove and hereinbelow.

The rubber portion 54 is molded onto an internal face of the metal shield portion 52, where the “internal face” is understood to be a surface facing inwardly into in the internal volume of the sealed bearing 10 enclosed by the seal bodies 50a, 50b, toward the rolling elements 40. In this manner, the rubber portion 54 and the metal shield portion 52 are respective annular portions that are formed into an integral unit to provide a sealing function for the sealed bearing 10. As particularly shown in FIGS. 2 and 3, the rubber portion 54 is molded onto the internal face of the metal shield portion 52 from the first outer ring groove 28a and extends beyond the metal shield 52 into the inner ring groove 38a, for providing tight sealing.

The outer ring interior surface 24 also includes first and second outer ring gap surfaces 60a, 60b, each defining the inset between the respective first and second outer ring grooves 28a, 28b and the respective first and second outer ring edge surfaces 26a, 26b. That is to say, the first outer ring gap surface 60a defines the inset between the first outer ring groove 28a and the first outer ring edge surface 26a. Correspondingly, the second outer ring gap surface 60b defines the inset between the second outer ring groove 28b and the second outer ring edge surface 26b.

As shown especially in FIG. 2, the respective outer ring gap surfaces 60a. 60b are offset from the outer ring interior cylindrical surface 24. In other words, the outer ring gap surfaces 60a, 60b have a greater annular radius than the annular radius of the outer ring interior cylindrical surface 24. In this manner, the outer ring gap surfaces 60a, 60b are configured to receive a first protruding portion of the respective seal body 50a, 50b, as will be explained in detail hereinbelow.

The inner ring exterior surface 32 similarly includes first and second inner ring gap surfaces 62a, 62b, each defining the inset between the respective first and second inner ring grooves 38a, 38b and the respective first and second inner ring edge surfaces 36a, 36b. That is to say, the first inner ring gap surface 62a defines the inset between the first inner ring groove 38a and the first inner ring edge surface 36a. Correspondingly, the second inner ring gap surface 62b defines the inset between the second inner ring groove 38b and the second inner ring edge surface 36b.

As also shown especially in FIG. 2, the respective inner ring gap surfaces 62a, 62b are offset from the inner ring exterior cylindrical surface 32. In other words, the inner ring gap surfaces 62a, 62b have a greater annular radius than the annular radius of the inner ring exterior cylindrical surface 32. In this manner, the inner ring gap surfaces 62a, 62b are configured to receive a second protruding portion of the respective seal body 50a, 50b, as will be explained in detail hereinbelow.

The first and second protruding portions of the seal body 50a, 50b include a curled end 66 of the metal shield portion 52 (shown particularly in FIG. 3) or a labyrinth seal 64 of the rubber portion 54, each of which provide additional sealing to the present sealed bearing 10. Exemplary embodiments are contemplated in which either the labyrinth seal 64 or the curled end 66 can be received in either the outer ring gap surfaces 60a, 60b or the inner ring gap surfaces 62a, 62b. However, in the preferred embodiment, as shown in the figures, seal 50a is configured so that the curled end 66 is received in the outer ring gap surface 60a and the labyrinth seal 64 is received in the inner ring gap surface 62a. In this manner, the metal shield portion 52 with the curled end 66 allows for rigid mounting of the seal body 50a and superior protection against external debris damage.

As shown especially in FIG. 2, the labyrinth seal 64 is an extension of the rubber portion 54 that rests upon the respective inner ring gap surface 62a. The main body of the rubber portion 54 engages directly in the respective inner ring groove 38a. In this manner, the rubber portion 54 with the labyrinth seal 64 provides a double layer of sealing

As shown especially in FIG. 3, the rubber portion 54 includes a tight seal portion 68 interposed between the metal shield portion 52 and the respective outer ring groove 28a. This tight seal portion 68 is tightly fitted by the pressure of the curled end 66 against the respective gap surface 60a and thus provides a secure seal.

The present sealed bearing 10 further includes a lubricant such as grease winch maintained around the rolling elements 40 and retained in an internal space between the respective first and second seal bodies 50a, 50b of the first and second seals. As is to be appreciated, the lubricant reduces friction between the rolling elements 40 and the outer and inner rings 20, 30, as is understood in the art.

The present sealed bearing 10 and associated seal bodies 50a, 50b function as trash guard seals having the combined features of a pressed metal shield along with a synthetic rubber labyrinth seal. The present sealed bearing 10 provides a bearing design with superior protection against external debris damage, improper handling, and/or aggressive installation while also providing improved sealing all around the outer and inner rings 20, 30 of the sealed bearing 10.

As provided by the present invention, the metal shield 52 with curled end 66 pressed into the outer ring groove 28a allows for rigid mounting and superior protection against external debris damage. The oil-resistant synthetic rubber portion 54 of the seal body 50a including the labyrinth seal 64 creates an excellent seal between the inner ring groove 38a. This labyrinth design between the seal lip and inner ring groove 38a creates excellent protection against water intrusion while also preventing lubricant (i.e., grease) from leaving the interior of the bearing, which in turn keeps the bearing running efficiently longer.

The sealed bearing 10 of the present invention was tested in various dust chambers, muddy water test, and field testing. The present sealed bearing 10 with the “RSXT” seal design consistently performed 20%-30% longer when compared to a conventional seal design. The sealed bearing 10 of the present invention is especially suitable for lawn movers and similar application where an extreme environment is an issue.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. A sealed bearing comprising:
a generally cylindrical outer ring having an exterior cylindrical surface and an interior cylindrical surface, and having first and second outer ring edge surfaces spanning the respective exterior and interior cylindrical surfaces;
wherein the interior cylindrical surface of the outer ring comprises first and second outer ring grooves, each inset from the respective first and second outer ring edge surfaces;
a generally cylindrical inner ring having an exterior cylindrical surface and an interior cylindrical surface, and having first and second inner ring edge surfaces spanning the respective exterior and interior cylindrical surfaces;
wherein the exterior cylindrical surface of the inner ring comprises first and second inner ring grooves, each inset from the respective first and second inner ring edge surfaces;
a plurality of rolling elements retained between the interior cylindrical surface of the outer ring and the exterior cylindrical surface of the inner ring, to provide rolling contact with both the outer and inner rings; and
first and second seals, interposed between the outer ring and the inner ring, wherein the first seal is retained between the first outer ring groove and the first inner ring groove, and wherein the second seal is retained between the second outer ring groove and the second inner ring groove;
wherein the first and second seals each comprise:
a metal shield portion for engaging a respective one of the outer or inner ring grooves, for providing rigid mounting of the seal, and
a rubber portion for engaging the respective other of the outer or inner ring grooves, wherein the rubber portion is molded onto an internal face of the metal shield portion and extends beyond the metal shield portion into the respective groove, for providing tight sealing.

2. The sealed bearing of claim 1, wherein the plurality of rolling elements comprises bearing balls and wherein the interior cylindrical surface of the outer ring comprises an outer ring ball raceway and the exterior cylindrical surface of the inner ring comprises an inner ring ball raceway, wherein the respective ball raceways define contact surfaces for the rolling contact between the bearing balls and the outer and inner rings.

3. The sealed bearing of claim 2, wherein the respective ball raceways comprise concave surfaces having a mating relationship to a convex diameter of the plurality of bearing balls.

4. The sealed bearing of claim 1, further comprising:
first and second outer ring gap surfaces, each defining the inset between the respective first and second outer ring grooves and the respective first and second outer ring edge surfaces,
wherein the respective outer ring gap surfaces are offset from the interior cylindrical surface of the outer ring to receive a first protruding portion of the respective seal, and
first and second inner ring gap surfaces, each defining the inset between the respective first and second inner ring grooves and the respective first and second inner ring edge surfaces;
wherein the respective inner ring gap surfaces are offset from the exterior cylindrical surface of the inner ring to receive a second protruding portion of the respective seal.

5. The sealed bearing of claim 4, wherein the first and second protrading portions comprise a curled end of the metal shield portion or a labyrinth seal of the rubber portion, for providing additional sealing.

6. The sealed bearing of claim 5, wherein the labyrinth seal is an extension of the rubber portion that rests upon a respective gap surface.

7. The sealed bearing of claim 1, wherein the first and second seals are generally annular, each having an outer diameter and an inner diameter, and wherein:
the respective metal shield portions of the first and second seals define the outer diameter and engage a respective outer ring groove, and wherein
the respective rubber portions of the first and second seals define the inner diameter and engage a respective inner ring groove.

8. The sealed bearing of claim 1, wherein the rubber portion includes a tight seal portion interposed between the metal shield portion and the respective groove.

9. The sealed bearing of claim 1, further a comprising a lubricant maintained around the rolling elements and retained between the first and second seals.

10. A seal for a bearing, comprising:
a seal body for interposition between an outer ring and an inner ring of a bearing, wherein the seal body is retained between an outer ring groove formed on the outer ring and an inner ring groove formed on the inner ring, wherein the seal body further comprises:
a metal shield portion for engaging a respective one of the outer or inner ring grooves, for providing rigid mounting of the seal, and
a rubber portion for engaging the respective other of the outer or inner ring grooves, wherein the rubber portion is molded onto an internal face of the metal shield portion and extends beyond the metal shield portion into the respective groove, for providing tight sealing.

11. The seal claim 10, wherein metal shield portion comprises a curled end for providing additional sealing in the respective one of the outer or inner ring grooves.

12. The seal of claim 10, wherein the rubber portion comprises a labyrinth seal for providing additional sealing in the respective one of the outer or inner ring grooves.

13. The seal of claim 12, wherein the labyrinth seal is an extension of the rubber portion that rests upon a respective gap surface adjoining the respective one of the outer or inner ring grooves.

14. The seal of claim 10, wherein the seal body is generally annular, having an outer diameter and an inner diameter, and wherein:
the metal shield portion defines the outer diameter and engages a respective outer ring groove, and wherein
the rubber portion defines the inner diameter and engages a respective inner ring groove.

15. The seal of claim 1, wherein the rubber portion includes a tight seal portion interposed between the metal shield portion and the respective groove.
